(19) United States
(12) Patent Application Publication
(10) Pub. No.: US 2014/0347986 A1
(43) Pub. Date: Nov. 27, 2014

(54) WIRELESS COMMUNICATION DEVICE, WIRELESS COMMUNICATION METHOD, AND WIRELESS COMMUNICATION CONTROL PROGRAM

(71) Applicant: Panasonic Corporation, Osaka (JP)

(72) Inventors: Satoshi Senga, Osaka (JP); Shinichiro Nishioka, Osaka (JP)

(73) Assignee: Panasonic Corporation, Osaka (JP)

(21) Appl. No.: 14/362,549

(22) PCT Filed: Jun. 28, 2013
(86) PCT No.: PCT/JP2013/004057

§ 371 Date: Jun. 3, 2014

(30) Foreign Application Priority Data
Oct. 9, 2012 (JP) 2012-224081

(51) Int. Cl. H04W 28/02

(52) U.S. Cl. CPC H04W 28/0278
USPC 370/230

(57) ABSTRACT

A radio communication apparatus is disclosed that increases the speed of arrival-guaranteed data communication with another radio communication apparatus. The radio communication apparatus includes a MAC layer section and a protocol adaptation layer (PAL) section located higher than the MAC layer. The protocol adaptation layer section indicates, to the other radio communication apparatus, a virtual value greater than an actual size of a receiving buffer memory shared with the MAC layer, before starting reception of data. The protocol adaptation layer section writes the data received from the other radio communication apparatus and stored, to a data storage section from the receiving buffer memory. The protocol adaptation layer section generates a PAL acknowledgment and transmits the acknowledgment to the other radio communication apparatus when a total size of the written data reaches the virtual value.

### TECHNICAL FIELD

The present invention relates to a radio communication apparatus, a radio communication method, and a radio communication control program that enable efficient reception of data from another radio communication apparatus.

### BACKGROUND ART

Communication apparatuses capable of transmitting and receiving content data such as moving images and still images to and from other communication apparatuses by radio or wire have become popular. With such a trend, techniques that optimize a communication speed of content data transmitted or received in accordance with its application have been proposed.

PTL 1 discloses an arrival-guaranteed data communication method as an example of the above-described techniques. The arrival-guaranteed data communication method is performed, for example, by the following procedure.

A transmitting apparatus transmits data to a receiving apparatus. Upon receiving data from the transmitting apparatus, the receiving apparatus transmits an acknowledgment to the transmitting apparatus. The acknowledgment is data for indicating which data has been successfully processed in reception processing, using an identification number. Reception of the acknowledgment from the receiving apparatus allows the transmitting apparatus to assure that the receiving apparatus has successfully received the data transmitted by the transmitting apparatus.

In such an arrival-guaranteed data communication method, the amount of data that can be transmitted from the transmitting apparatus to the receiving apparatus without waiting for an acknowledgment is limited by the size of a receiving buffer memory (hereinafter, referred to as “receiving buffer memory”) included in the receiving apparatus. The details of the limitation will be described below.

First, the transmitting apparatus and the receiving apparatus indicate, to each other, a value indicating the size of the receiving buffer memory of each apparatus (hereinafter, referred to as “receiving buffer size”) in a setup stage before starting communication. The receiving buffer size indicated at this time is, for example, a value indicating a maximum amount of storing the received data. When communication starts, the transmitting apparatus transmits data corresponding to the receiving buffer size indicated from the receiving apparatus to the receiving apparatus. After that, the transmitting apparatus does not transmit data but waits to receive an acknowledgment from the receiving apparatus. Upon receiving an acknowledgment from the receiving apparatus, the transmitting apparatus transmits data corresponding to the receiving buffer size indicated from the receiving apparatus to the receiving apparatus again.

Specifically, the greater the receiving buffer size indicated from the receiving apparatus before starting communication is, the greater the amount of data that the transmitting apparatus can transmit without waiting for an acknowledgment. As the amount of data transmittable without waiting for an acknowledgment increases, the transmitting apparatus can increase the data communication speed accordingly.

### CITATION LIST

### Patent Literature

PTL 1
Japanese Patent Application Laid-Open No. 2005-109765

### SUMMARY OF INVENTION

### Technical Problem

However, there are radio communication apparatuses such as small mobile devices that cannot be provided with any large-size receiving buffer memory due to limitations of cost, mounting area, and power consumption. When used for a receiving apparatus using an arrival-guaranteed data communication method, such radio communication apparatuses have the following problems.

Specifically, since the receiving apparatus has a small receiving buffer size, the transmitting apparatus has a less amount of data transmittable without waiting for an acknowledgment. Accordingly, the receiving apparatus more frequently has to send back acknowledgments. As a result, the transmitting apparatus has to wait for more time to receive an acknowledgment. As described above, while waiting to receive an acknowledgment, the transmitting apparatus cannot transmit data. Therefore, the receiving apparatus with a small receiving buffer size has a problem of decrease in the communication speed of the arrival-guaranteed data communication method.

An object of the present invention is to increase a communication speed for arrival-guaranteed data even when a receiving buffer size is small.

### Solution to Problem

A radio communication apparatus according to an aspect of the present invention is a radio communication apparatus that performs radio communication with another radio communication apparatus using arrival-guaranteed data communication, the radio communication apparatus including: a MAC (Media Access Control) layer section that temporarily stores data received from the other radio communication apparatus in a receiving buffer memory; and a protocol adaptation layer (PAL) section that indicates, to the other radio communication apparatus, as a virtual receiving buffer size, a value greater than an actual size of the receiving buffer memory shared with the MAC layer, before starting reception of data from the other radio communication apparatus, that writes the data stored in the receiving buffer memory to a recording medium, that generates an acknowledgment when a total size of the data written to the recording medium reaches the virtual receiving buffer size, and that transmits the acknowledgment to the other radio communication apparatus.

A radio communication method according to an aspect of the present invention is a radio communication method for performing radio communication with a radio communication apparatus using arrival-guaranteed data communication, the radio communication method including: indicating, by a protocol adaptation layer section to the radio communication apparatus, as a virtual receiving buffer size, a value greater than the actual size of a receiving buffer memory shared with a MAC (Media Access Control) layer section, before reception of data from the radio communication apparatus starts; temporarily storing, by the MAC layer section, the data received from the radio communication apparatus in the receiving buffer memory; writing the data from the receiving buffer memory to a recording medium by the protocol adaptation layer section; and generating an acknowledgment and transmitting the acknowledgment to the radio communication apparatus by the protocol adaptation layer section when a total size of the data written to the recording medium reaches the virtual receiving buffer size.

A radio communication control program according to an aspect of the present invention is a radio communication program to be executed by a computer of an apparatus that performs radio communication with another radio communication apparatus using arrival-guaranteed data communication, the radio communication control program causing the computer to execute processes including: indicating, by a protocol adaptation layer section to the other radio communication apparatus, as a virtual receiving buffer size, a value greater than the actual size of a receiving buffer memory shared with a MAC (Media Access Control) layer section, before reception of data from the other radio communication apparatus starts; temporarily storing, by the MAC layer section, the data received from the other radio communication apparatus in the receiving buffer memory; writing the data from the receiving buffer memory to a recording medium by the protocol adaptation layer section; and generating an acknowledgment and transmitting the acknowledgment to the other radio communication apparatus by the protocol adaptation layer section when a total size of the data written to the recording medium reaches the virtual receiving buffer size.

### Advantageous Effects of Invention

The present invention can increase the communication speed for arrival-guaranteed data in communication with another radio communication apparatus.

### BRIEF DESCRIPTION OF DRAWINGS

FIG. 1 is a block diagram illustrating a configuration example of a communication system according to the present embodiment;

FIG. 2 illustrates a format example of setup data according to the present embodiment;

FIG. 3 illustrates a format example of received data according to the present embodiment;

FIG. 4 illustrates a format example of a PAL acknowledgment according to the present embodiment;

FIG. 5 illustrates a format example of a MAC acknowledgment according to the present embodiment;

FIG. 6 is a flowchart illustrating an operation example of a radio communication apparatus on the receiving side according to the present embodiment; and

FIG. 7 is a sequence diagram illustrating an operation example of the communication system according to the present embodiment.

### DESCRIPTION OF EMBODIMENT

Hereinafter, an embodiment of the present invention will be described in detail with reference to the accompanying drawings.

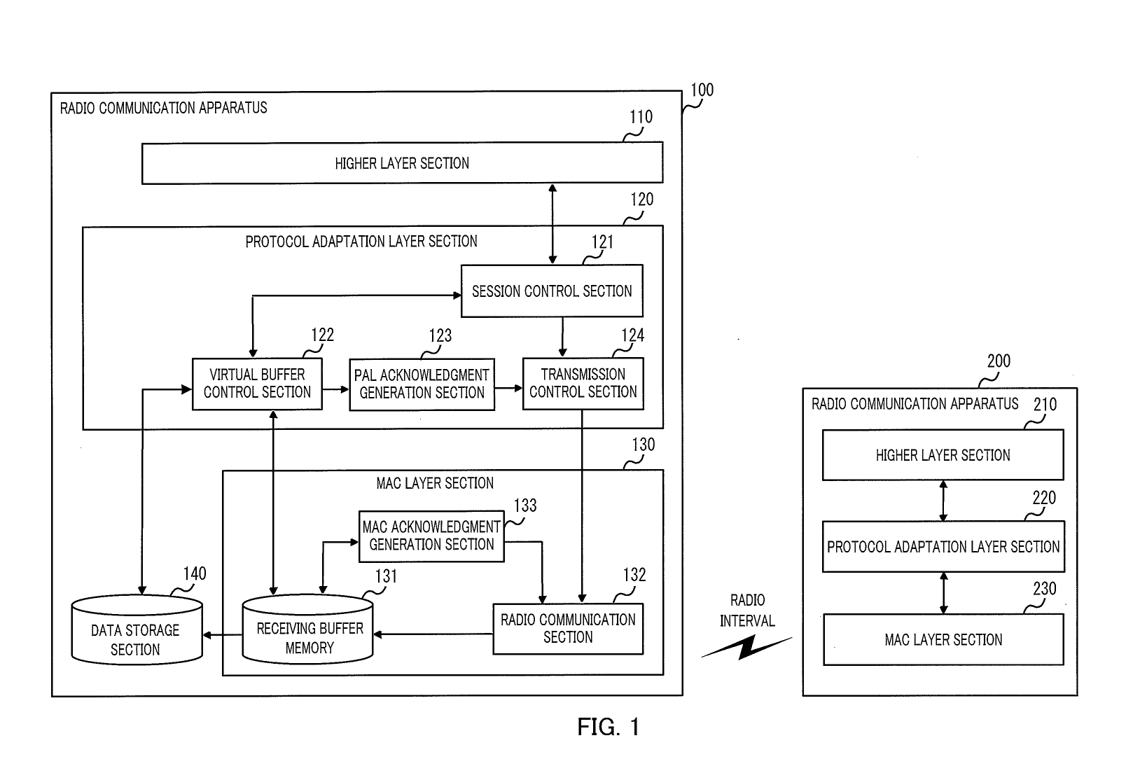

FIG. 1 illustrates a configuration example of a communication system according to the present embodiment. A case of the communication system according to the present embodiment will be described as an example where radio communication apparatus 100 performs reception processing on arrival-guaranteed data in radio communication with radio communication apparatus 200.

<Configuration of Radio Communication Apparatus 100>

First, a configuration of radio communication apparatus 100 will be described.

In FIG. 1, radio communication apparatus 100 according to the present embodiment is a receiving apparatus. Specifically, radio communication apparatus 100 is an apparatus that receives data from radio communication apparatus 200 through radio communication and stores the data in data storage section 140.

As shown in FIG. 1, radio communication apparatus 100 includes higher layer section 110, protocol adaptation layer section 120, MAC layer section 130, and data storage section 140. Protocol adaptation layer section 120 includes session control section 121, virtual buffer control section 122, PAL acknowledgment generation section 123, and transmission control section 124. MAC layer section 130 includes receiving buffer memory 131, radio communication section 132, and MAC acknowledgment generation section 133. The term “MAC” mentioned above is an abbreviation of Media Access Control. The term “PAL” is an abbreviation of Protocol Adaptation Layer.

Higher layer section 110 is a layer located higher than protocol adaptation layer section 120 in a protocol hierarchical structure of an OSI (Open Systems Interconnection) reference model in which a communication function is divided into layers in a hierarchical structure. Higher layer section 110 is, for example, an application that receives data from radio communication apparatus 200.

Triggered by, for example, an operation by a user, higher layer section 110 performs a preliminary setup first, and then instructs protocol adaptation layer section 120 to start receiving data from radio communication apparatus 200. This instruction is called “reception start instruction.” The preliminary setup includes a setup for radio communication apparatus 100 and a setup for the communicating counterpart (radio communication apparatus 200). The former includes, for example, processing of instructing protocol adaptation layer section 120 about data writing destination. On the other hand, the latter includes, for example, processing of starting (establishing) a session with radio communication apparatus 200 and processing of indicating the receiving buffer size of radio communication apparatus 100 to radio communication apparatus 200.

Protocol adaptation layer section 120 is a layer located between higher layer section 110 which is a higher layer and MAC layer section 130 which is a lower layer in the protocol hierarchical structure of the OSI reference model. Specifically, protocol adaptation layer section 120 assumes establishment of matching between the higher layer and the lower layer as a basic function. More specifically, protocol adaptation layer section 120 absorbs the nature specific to each service provided by a higher application so that lower radio layers can be commonly defined without depending on the service.

Here, session control section 121, virtual buffer control section 122, PAL acknowledgment generation section 123 and transmission control section 124 provided for protocol adaptation layer section 120 will be each described.

Upon receiving an instruction for starting reception from higher layer section 110, session control section 121 transmits a session start request to transmission control section 124. The session start request is data for requesting radio communication apparatus 200 to start a session. Session control section 121 receives a session start response from radio communication apparatus 200 as data of a response to the session start request. This session start response is indicated to session control section 121 via radio communication section 132, receiving buffer memory 131 and virtual buffer control section 122.

Upon receiving the session start response, session control section 121 inquires virtual buffer control section 122 about the size (capacity) of receiving buffer memory 131. Here, the size queried about by session control section 121 is a maximum value of the size of receiving buffer memory 131. Note that virtual buffer control section 122 acquires the size of receiving buffer memory 131 beforehand in preparation for inquiries from session control section 121.

Session control section 121 determines the receiving buffer size for indication to radio communication apparatus 200 based on the inquiry result. The receiving buffer size for indication referred to here is a value indicating a virtual size of receiving buffer memory 131 (hereinafter, referred to as “virtual receiving buffer size”). An example of the method of determining this virtual receiving buffer size will be described below. For example, session control section 121 determines a value greater than the inquired size (actual size) of receiving buffer memory 131 to be the virtual receiving buffer size. Session control section 121 may also determine a value greater than the inquired size of receiving buffer memory 131 and smaller than an upper limit value defined in a communication protocol of protocol adaptation layer section 120 to be the virtual receiving buffer size, for example. Specifically, instead of designating the inquired size of receiving buffer memory 131 as the receiving buffer size for indication as is, session control section 121 determines a value greater than that to be the receiving buffer size for indication as the virtual receiving buffer size.

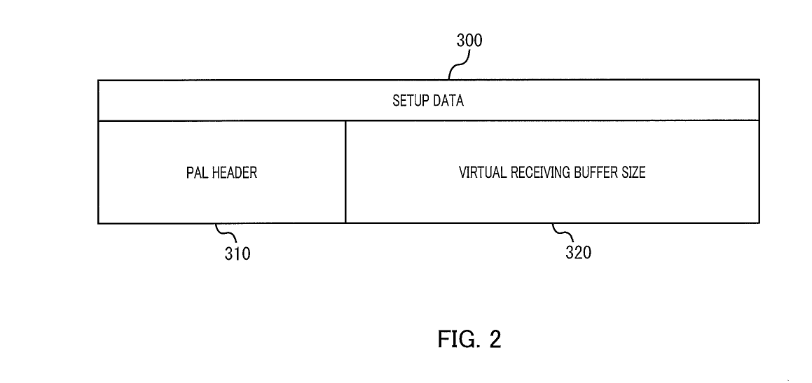

Session control section 121 indicates, to virtual buffer control section 122, the determined virtual receiving buffer size. On the other hand, session control section 121 generates setup data (300 in FIG. 2) including the determined virtual receiving buffer size and transmits the setup data to transmission control section 124. The format of the setup data will be described later with reference to FIG. 2.

Session control section 121 instructs virtual buffer control section 122 about the writing destination of data received from radio communication apparatus 200 based on the instruction for starting reception from higher layer section 110. Here, as an example, the writing destination is assumed to be data storage section 140. Session control section 121 may indicate, to virtual buffer control section 122, the virtual receiving buffer size, and also instruct virtual buffer control section 122 about the writing destination.

Thus, even when the actual size of receiving buffer memory 131 is small, session control section 121 indicates, to radio communication apparatus 200, a value greater than the actual size as the virtual receiving buffer size. This allows radio communication apparatus 200 to increase a maximum value of data transmittable to radio communication apparatus 100 without obtaining any PAL acknowledgment. As a result, radio communication apparatus 200 of the present embodiment can increase the speed of reception processing on arrival-guaranteed data.

Virtual buffer control section 122 acquires the size of receiving buffer memory 131 beforehand in preparation for an inquiry from session control section 121. This acquisition timing is, for example, timing of starting or initialization of an application using protocol adaptation layer section 120. Upon receiving an inquiry from session control section 121, virtual buffer control section 122 indicates, to session control section 121, the size of receiving buffer memory 131 acquired beforehand.

Virtual buffer control section 122 receives and stores the indication of the virtual receiving buffer size from session control section 121.

Upon receiving, from session control section 121, an instruction about the writing destination of the data received from radio communication apparatus 200, virtual buffer control section 122 performs reception preparation processing on the writing destination. Specifically, virtual buffer control section 122 starts a power supply or initializes a writing region for data storage section 140 which is the writing destination.

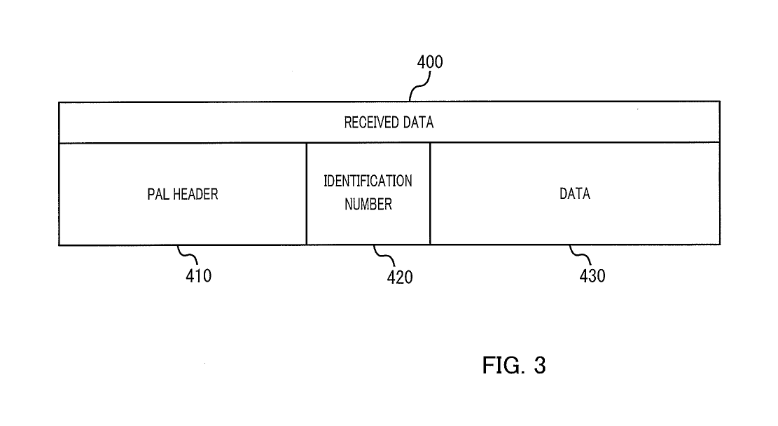

Virtual buffer control section 122 removes a PAL header (410 in FIG. 3) from data (400 in FIG. 3) accumulated in receiving buffer memory 131 and writes only data actually used by the user (430 in FIG. 3) to data storage section 140. Virtual buffer control section 122 then releases (deletes) data (400 in FIG. 3) including the data which has already been written (430 in FIG. 3) from receiving buffer memory 131. At this time, virtual buffer control section 122 adds the size of the written data every time data is written and stores the result thereof as an additional value (total value). Virtual buffer control section 122 stores an identification number (420 in FIG. 3) of the last written data.

When the additional value of the size of the written data is equal to the virtual receiving buffer size, virtual buffer control section 122 transmits an instruction for generating a PAL acknowledgment to PAL acknowledgment generation section 123. At this time, virtual buffer control section 122 indicates the identification number of the last written data to PAL acknowledgment generation section 123. Note that virtual buffer control section 122 may substitute only indication of the identification number of the last written data for the instruction for generating a PAL acknowledgment.

Thus, virtual buffer control section 122 controls generation timing of PAL acknowledgment 500 based on the virtual receiving buffer size and an additional value of sizes of data written to data storage section 140. This requires radio communication apparatus 100 to generate only one PAL acknowledgment for a virtual receiving buffer size larger than the actual size of receiving buffer memory 131. Therefore, it is possible to reduce the number of PAL acknowledgment transmissions from radio communication apparatus 100. It is also possible to reduce the frequency of waiting times for a PAL acknowledgment of radio communication apparatus 200. As a result, radio communication apparatus 200 of the present embodiment can increase the speed of communication processing on arrival-guaranteed data.

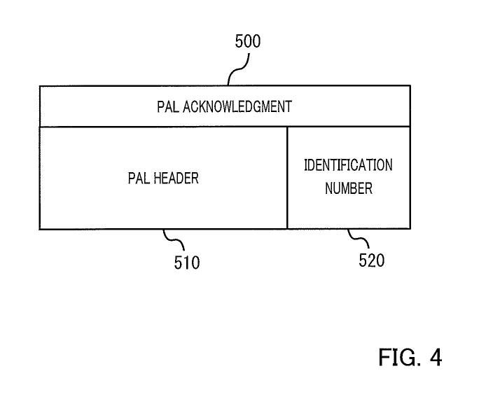

Upon receiving the instruction for generating a PAL acknowledgment from virtual buffer control section 122, PAL acknowledgment generation section 123 generates a PAL acknowledgment (500 in FIG. 4) based on the indicated identification number. PAL acknowledgment generation section 123 transmits the generated PAL acknowledgment to transmission control section 124. The format of the PAL acknowledgment will be described later with reference to FIG. 4.

Transmission control section 124 transfers data received from session control section 121 or PAL acknowledgment generation section 123 to radio communication section 132. The data from session control section 121 is, for example, a session start request and setup data. The data from PAL acknowledgment generation section 123 is, for example, a PAL acknowledgment.

MAC layer section 130 is a layer located lower than protocol adaptation layer section 120 in the protocol hierarchical structure of the OSI reference model. Here, receiving buffer memory 131, radio communication section 132 and MAC acknowledgment generation section 133 of MAC layer section 130 will be each described.

Receiving buffer memory 131 is a physical memory that temporarily stores data received by radio communication apparatus 100 from radio communication apparatus 200. Receiving buffer memory 131 is shared by MAC layer section 130 and protocol adaptation layer section 120. When reception processing on data in MAC layer section 130 ends, the reception processing on the data in receiving buffer memory 131 transitions to protocol adaptation layer section 120. Virtual buffer control section 122 removes the PAL header (410 in FIG. 3) from the data (400 in FIG. 3) temporarily stored in receiving buffer memory 131. Virtual buffer control section 122 performs control so as to write only the data (430 in FIG. 3) actually used by the user to data storage section 140. Virtual buffer control section 122 then releases (deletes) the data (400 in FIG. 3) including the written data (430 in FIG. 3) from receiving buffer memory 131.

Thus, receiving buffer memory 131 is shared by MAC layer section 130 and protocol adaptation layer section 120. Here, the advantage of receiving buffer memory 131 being shared by MAC layer section 130 and protocol adaptation layer section 120 will be described.

First, the disadvantage of the receiving buffer memory not being shared by the MAC layer section and the protocol adaptation layer section will be described. For example, a case will be described where the receiving apparatus uses different receiving buffer memories for the MAC layer section and the protocol adaptation layer section, and the virtual receiving buffer size is indicated to the transmitting apparatus. In this case, an overflow may occur in data received in the receiving apparatus depending on the speed of data input to the MAC layer section and the speed of data output from the protocol adaptation layer section. In this case, different communication protocols are used for the MAC layer section and the protocol adaptation layer section. This is because as a result, in the receiving apparatus, timing at which the MAC layer section transmits a MAC acknowledgment to the transmitting apparatus differs from the timing at which the protocol adaptation layer section transmits a PAL acknowledgment to the transmitting apparatus.

In contrast, when receiving buffer memory 131 is shared by MAC layer section 130 and protocol adaptation layer section 120, and radio communication apparatus 100 indicates the virtual receiving buffer size to radio communication apparatus 200, the operation is as follows. Specifically, in radio communication apparatus 100, the speed of data input to receiving buffer memory 131 is limited in accordance with the speed of data output from receiving buffer memory 131 to data storage section 140. Specifically, under flow control of MAC layer section 130 through a MAC acknowledgment, data reception from radio communication apparatus 200 is restricted by MAC layer section 130 located lower than protocol adaptation layer section 120. The amount of data continuously transmitted from radio communication apparatus 200 in excess of the capacity of MAC layer section 130 is not received. For this reason, no overflow occurs in data received from radio communication apparatus 200.

Radio communication section 132 adds a MAC header to the data received from transmission control section 124 and transmits the data to radio communication apparatus 200 via a radio interval. As described above, this data corresponds to a session start request, setup data and PAL acknowledgment. Radio communication section 132 transmits the data received from MAC acknowledgment generation section 133 to radio communication apparatus 200 via the radio interval. This data corresponds to a MAC acknowledgment which will be described later. Radio communication section 132 transfers the data received from radio communication apparatus 200 to receiving buffer memory 131 via the radio interval. This data corresponds to a session start response and received data (400 in FIG. 3) which will be described later.

Radio communication section 132 is a radio communication interface such as a wireless LAN (Local Area Network) device, and a WiGig (Wireless Gigabit) device. The term “WiGig” refers to a radio communication standard using a millimeter wave of a 60 GHz band intended for substitution of wired PAN application exceeding 1 Gbps. The radio communication standard used by radio communication section 132 is not limited to wireless LAN and WiGig. The radio communication standard used by radio communication section 132 may be any one of a standard that allows radio communication apparatus 100 and radio communication apparatus 200 to directly perform radio communication and a standard that makes possible radio communication via another apparatus.

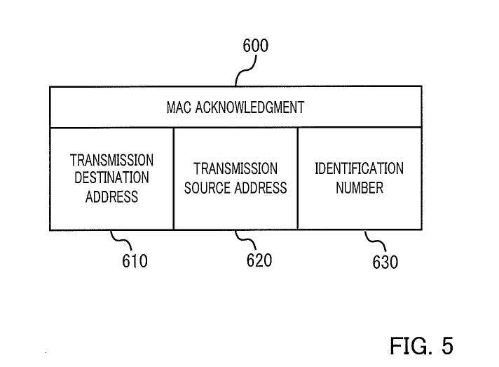

Upon detecting that the data of receiving buffer memory 131 (430 in FIG. 3) has been released, MAC acknowledgment generation section 133 generates a MAC acknowledgment based on the identification number of the released data (420 in FIG. 3). MAC acknowledgment generation section 133 then transmits the generated MAC acknowledgment to radio communication section 132. Specifically, the MAC acknowledgment is transmitted to radio communication apparatus 200 at timing at which the data is released from receiving buffer memory 131 by completion of data reception processing in protocol adaptation layer section 120. Thus, MAC layer section 130 continues the data reception processing in MAC layer section 130 by transmitting a MAC acknowledgment to radio communication apparatus 200. The format of the MAC acknowledgment will be described later with reference to FIG. 5.

Different communication protocols are used for MAC layer section 130 and protocol adaptation layer section 120. The difference in the communication protocols causes timing at which MAC layer section 130 transmits a MAC acknowledgment to radio communication apparatus 200 to differ from timing at which protocol adaptation layer section 120 transmits a PAL acknowledgment to radio communication apparatus 200. The transmission timing of MAC layer section 130 is timing of transmitting a MAC acknowledgment to radio communication apparatus 200 when data is received from radio communication apparatus 200. On the other hand, the transmission timing of protocol adaptation layer section 120 is timing of transmitting a PAL acknowledgment to radio communication apparatus 200 when data is received from MAC layer section 130.

Data storage section 140 is the writing destination of data from receiving buffer memory 131 (430 in FIG. 3) and is a non-volatile recording medium. The non-volatile recording medium is, for example, an SD, SDHC (SD High Capacity) or SDXC (SD eXtended Capacity) memory card. Higher layer section 110 can also read the data stored in data storage section 140 via protocol adaptation layer section 120 (virtual buffer control section 122 and session control section 121). The data stored in data storage section 140 is, for example, content data such as moving image or still image received from radio communication apparatus 200.

Even when the size of receiving buffer memory 131 is small, radio communication apparatus 100 can indicate a virtually large receiving buffer size to radio communication apparatus 200. Thus, radio communication apparatus 100 can reduce the number of times PAL acknowledgments are transmitted to radio communication apparatus 200. Therefore, the waiting time for radio communication apparatus 200 to receive a PAL acknowledgment from radio communication apparatus 100 decreases. As a result, radio communication apparatus 100 can increase the speed of receiving arrival-guaranteed data from radio communication apparatus 200 to which radio communication apparatus 100 is connected via radio communication.

The description of the configuration of radio communication apparatus 100 has been given thus far.

<Configuration of Radio Communication Apparatus 200>

Next, the configuration of radio communication apparatus 200 will be described.

In FIG. 1, radio communication apparatus 200 according to the present embodiment is an apparatus that transmits data requested by the user to radio communication apparatus 100 via radio communication.

Radio communication apparatus 200 includes higher layer section 210, protocol adaptation layer section 220 and MAC layer section 230.

Higher layer section 210 is a layer located higher than protocol adaptation layer section 120 in the protocol hierarchical structure of the OSI reference model. An example of higher layer section 210 is an application that generates data to be transmitted to radio communication apparatus 100 and transmits the data to radio communication apparatus 100.

Higher layer section 210 instructs protocol adaptation layer section 220 to start transmission of data to radio communication apparatus 100 by radio, triggered by, for example, an operation by the user. In such a case, higher layer section 210 generates data to be transmitted or reads the data from a predetermined storage medium or the like. Higher layer section 210 then outputs the data to be transmitted to a transmitting buffer (not shown) of protocol adaptation layer section 220. An example of the data to be transmitted is content data such as a moving image or still image.

Protocol adaptation layer section 220 is a layer located between higher layer section 210 which is a higher layer and MAC layer section 230 which is a lower layer in the protocol hierarchical structure of the OSI reference model. Specifically, protocol adaptation layer section 220 is a PAL whose basic function is to provide consistency between the higher layer and lower layer. Protocol adaptation layer section 220 includes a transmitting buffer (not shown).

Upon receiving an instruction for transmitting data to radio communication apparatus 100 from higher layer section 210, protocol adaptation layer section 220 applies data transmission preparation processing to data outputted to the transmitting buffer from higher layer section 210 together with the instruction. The data transmission preparation processing is processing that divides the data accumulated in the transmitting buffer and adds the PAL header (410 in FIG. 3) and continuous identification numbers (420 in FIG. 3) to each piece of the divided data (430 in FIG. 3). As a result of this processing, transmission data is generated. Protocol adaptation layer section 220 transmits the generated transmission data to MAC layer section 230. The transmission data referred to herein corresponds to received data 400 in FIG. 3.

MAC layer section 230 is a layer located lower than protocol adaptation layer section 220 in the protocol hierarchical structure of the OSI reference model. When performing radio communication with radio communication apparatus 100, MAC layer section 230 uses the same radio communication standard as that of radio communication section 132 of radio communication apparatus 100.

MAC layer section 230 transmits the transmission data received from protocol adaptation layer section 220 to radio communication apparatus 100 via a radio interval. More specifically, MAC layer section 230 adds a MAC header to the transmission data received from protocol adaptation layer section 220, generates a radio frame and transmits the radio frame to radio communication apparatus 100. After that, MAC layer section 230 waits to receive a MAC acknowledgment from radio communication apparatus 100. Upon receiving the MAC acknowledgment, MAC layer section 230 transmits transmission data which has not been transmitted yet. By this means, MAC layer section 230 repeats reception of MAC acknowledgments and transmission of transmission data which has not been transmitted yet until all the transmission data received from protocol adaptation layer section 220 is transmitted to radio communication apparatus 100.

Upon receiving a PAL acknowledgment from radio communication apparatus 100 via a radio interval, MAC layer section 230 transfers the PAL acknowledgment to protocol adaptation layer section 220.

Radio communication apparatus 200 controls the transmission of transmission data based on the MAC acknowledgment from radio communication apparatus 100, and can thereby achieve transmission of arrival-guaranteed data to radio communication apparatus 100.

Note that in radio communication apparatus 200 shown in FIG. 1, protocol adaptation layer section 220 and MAC layer section 230 may be each provided with the configurations of protocol adaptation layer section 120 and MAC layer section 130 of radio communication apparatus 100 as appropriate.

The description of the configuration of radio communication apparatus 200 has been given thus far.

Radio communication apparatus 100 and radio communication apparatus 200 respectively include a CPU (Central Processing Unit), a recording medium such as a ROM (Read Only Memory) that stores a control program, and a work memory such as a RAM (Random Access Memory). In this case, the above-described functions of the respective components are achieved by the CPU executing the control program.

Note that the respective functional blocks of radio communication apparatus 100 and radio communication apparatus 200 may also be configured of, for example, an integrated circuit. The respective functional blocks of radio communication apparatus 100 and radio communication apparatus 200 may be individual chips or a plurality thereof may be contained on a single chip. The integrated circuit may also be referred to as “LSI (Large Scale Integration),” “IC (Integrated Circuit),” “system LSI,” “super LSI,” or “ultra LSI” depending on differing extents of integration. Further, the integrated circuit may also be implemented using dedicated circuitry or a general purpose processor. After manufacture of the integrated circuit, utilization of a programmable FPGA (Field Programmable Gate Array) or a reconfigurable processor where connections and settings of circuit cells within an LSI can be reconfigured is also possible. Further, if integrated circuit technology that replaces LSI's comes out as a result of the advancement of semiconductor technology or a derivative other technology (for example, biotechnology), it is naturally also possible to carry out function block integration of radio communication apparatus 100 and radio communication apparatus 200 using this technology.

Though not shown, radio communication apparatus 100 and radio communication apparatus 200 according to the present embodiment may be each provided with a user interface for the user to select and execute an operation. For example, radio communication apparatus 100 and radio communication apparatus 200 according to the present embodiment may be each provided with functions such as input keys, display, microphone, speaker, camera, vibrator and memory for storage and execution of programs as a user interface.

The description of the configuration and contents of the radio communication apparatus according to the present embodiment has been given thus far.

Next, the formats of setup data 300, received data 400, PAL acknowledgment 500 and MAC acknowledgment 600 will be described.

<Format of Setup Data>

First, the format of setup data 300 will be described with reference to FIG. 2.

Setup data 300 is configured of PAL header 310 and virtual receiving buffer size 320. PAL header 310 defines information specific to each PAL, and is, for example, session information that realizes an application service. Virtual receiving buffer size 320 is a value indicating a virtual receiving buffer size determined by session control section 121.

As described above, setup data 300 is generated by session control section 121 and transmitted from radio communication apparatus 100 to radio communication apparatus 200.

<Format of Received Data>

Next, the format of received data 400 will be described with reference to FIG. 3.

Received data 400 is configured of PAL header 410, identification number 420 and data 430. PAL header 410 defines information specific to each PAL, and is, for example, session information for realizing an application service. Identification number 420 is a specific number that can identify data 400 and data 430, and is, for example, a sequence number. Data 430 is, for example, content data, is data actually used by the user, and is one portion of data divided and transmitted by radio communication apparatus 200.

As described above, received data 400 is transmitted from radio communication apparatus 200 as transmission data and received by radio communication apparatus 100.

<Format of PAL Acknowledgment>

Next, the format of PAL acknowledgment 500 will be described with reference to FIG. 4.

PAL acknowledgment 500 is configured of PAL header 510 and identification number 520. PAL header 510 defines information specific to each PAL, and is, for example, session information for realizing an application service. Identification number 520 is an identification number indicating received data 400 on which radio communication apparatus 100 has successfully completed processing. Specifically, identification number 520 is the same as identification number 420. In other words, identification number 520 is a specific number that can identify data outputted from a transmitting buffer of protocol adaptation layer section 220 to MAC layer section 230 in radio communication apparatus 200, and is, for example, a sequence number. A plurality of identification numbers 520 may also be included.

As described above, PAL acknowledgment 500 is generated by PAL acknowledgment generation section 123 and transmitted from radio communication apparatus 100 to radio communication apparatus 200.

<Format of MAC Acknowledgment>

Next, the format of MAC acknowledgment 600 will be described with reference to FIG. 5.

MAC acknowledgment 600 is configured of transmission destination address 610, transmission source address 620 and identification number 630. Transmission destination address 610 is an address of the apparatus that transmitted received data 400 (the apparatus that receives MAC acknowledgment 600), that is, an address of radio communication apparatus 200. Transmission source address 620 is an address of the apparatus that received received data 400 (the apparatus that transmits MAC acknowledgment 600), that is, an address of radio communication apparatus 100. The address referred to here is, for example, a MAC address. Identification number 630 is a number indicating received data 400 that has been successfully received by radio communication apparatus 100. Specifically, identification number 630 is the same as identification number 420.

As described above, MAC acknowledgment 600 is generated by MAC acknowledgment generation section 133 and transmitted from radio communication apparatus 100 to radio communication apparatus 200.

The description of the respective formats of setup data 300, received data 400, PAL acknowledgment 500 and MAC acknowledgment 600 has been given thus far.

<Operation of Radio Communication Apparatus 100>

Next, an example of operation of radio communication apparatus 100 will be described.

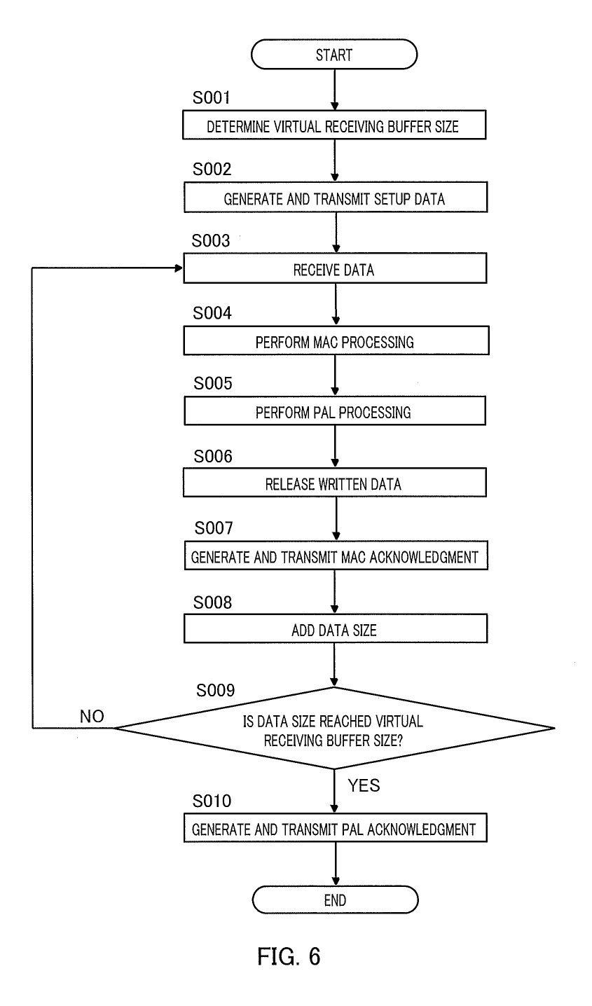

FIG. 6 is a flowchart illustrating an example of operation of radio communication apparatus 100.

In step S001, upon receiving an instruction for starting reception from higher layer section 110, session control section 121 transmits a session start request and receives a session start response, and then determines a virtual receiving buffer size. As described above, session control section 121 determines a value greater than at least the actual size of receiving buffer memory 131 about which session control section 121 queried virtual buffer control section 122 to be a virtual receiving buffer size.

Session control section 121 indicates, to virtual buffer control section 122, the determined virtual receiving buffer size and an instruction for writing received data 400 received from radio communication apparatus 200 to data storage section 140. Upon receipt of this indication, virtual buffer control section 122 stores the virtual receiving buffer size along with applying reception preparation processing (power supply start, initialization of writing region or the like) to data storage section 140.

In step S002, session control section 121 adds PAL header 310 to determined virtual receiving buffer size 320 and thereby generates setup data 300. Session control section 121 then transmits setup data 300 to radio communication apparatus 200 via transmission control section 124 and radio communication section 132. After that, radio communication apparatus 100 receives setup data including the receiving buffer size of radio communication apparatus 200 from radio communication apparatus 200. A session is thus established between radio communication apparatus 100 and radio communication apparatus 200 and data is ready to be transmitted and received.

In step S003, radio communication section 132 receives received data 400 from radio communication apparatus 200. Radio communication section 132 transfers received data 400 to receiving buffer memory 131.

In step S004, radio communication section 132 performs MAC processing on received data 400 accumulated in receiving buffer memory 131. MAC processing is reception processing of radio communication based on the MAC header necessary for radio communication. More specifically, the MAC processing is confirmation of a transmission source MAC address (MAC address of radio communication apparatus 200), transmission destination MAC address (MAC address of radio communication apparatus 100), data consistency and decoding of decrypted data or the like. After completion of the MAC processing, radio communication section 132 indicates completion of the MAC processing to virtual buffer control section 122.

In step S005, upon receipt of the indication of completion of the MAC processing, virtual buffer control section 122 performs PAL processing on received data 400 accumulated in receiving buffer memory 131. The PAL processing is PAL reception processing based on PAL header 410. More specifically, the PAL processing corresponds to confirmation as to whether the received data is control (session) data or received data 400 and confirmation of identification number 420 when the received data is received data 400. Virtual buffer control section 122 performs control so as to remove PAL header 410 from received data 400 after completion of the PAL processing and write only data 430 to data storage section 140. Note that when the data accumulated in receiving buffer memory 131 is not received data 400 but control data, virtual buffer control section 122 does not write the control data to data storage section 140 but transmits the control data to session control section 121. The control data is, for example, the aforementioned session start response, and in addition, data indicating stop of transfer or data indicating an end of a session or the like.

In step S006, when writing of data 430 to data storage section 140 is completed, virtual buffer control section 122 releases received data 400 including data 430 which has already been written from receiving buffer memory 131.

In step S007, MAC acknowledgment generation section 133 detects that received data 400 accumulated in receiving buffer memory 131 has been released. MAC acknowledgment generation section 133 then generates MAC acknowledgment 600 based on identification number 420 of released received data 400. In FIG. 5, identification number 630 corresponds to identification number 420. MAC acknowledgment generation section 133 then transmits generated MAC acknowledgment 600 to radio communication apparatus 200 via radio communication section 132.

MAC layer section 230 of radio communication apparatus 200 transmits next received data 400 based on received MAC acknowledgment 600.

In step S008, virtual buffer control section 122 adds the size of data 430 which has already been written every time data 430 is written to data storage section 140 and stores the result thereof as an additional value. Virtual buffer control section 122 stores identification number 420 of last written data 430.

In step S009, virtual buffer control section 122 determines whether or not the stored additional value has reached the virtual receiving buffer size indicated from session control section 121.

As a result of the determination in step S009, if the additional value has not reached the virtual receiving buffer size (S009: NO), the flow returns to step S003. Virtual buffer control section 122 waits to receive processing on received data 400 to be received next (indication of completion of MAC processing from MAC layer section 130).

When the determination result in step S009 shows that the additional value has reached the virtual receiving buffer size (S009: YES), the flow moves to step S010. In this case, virtual buffer control section 122 instructs PAL acknowledgment generation section 123 to generate PAL acknowledgment 500 and also indicates identification number 420 of last written data 430 to PAL acknowledgment generation section 123.

In step S010, PAL acknowledgment generation section 123 generates PAL acknowledgment 500 based on identification number 420 indicated from virtual buffer control section 122. In FIG. 4, identification number 520 corresponds to identification number 420. PAL acknowledgment generation section 123 transmits generated PAL acknowledgment 500 to radio communication apparatus 200 via transmission control section 124 and radio communication section 132.

Thus, radio communication apparatus 100 virtually increases receiving buffer size 320 and indicates receiving buffer size 320 to radio communication apparatus 200, and can thereby increase the amount of data that can be transmitted by radio communication apparatus 200 to radio communication apparatus 100 without waiting for PAL acknowledgment 500. Thus, radio communication apparatus 100 can reduce the number of times PAL acknowledgment 500 is indicated to radio communication apparatus 100. Accordingly, the time for which radio communication apparatus 200 has to wait to receive PAL acknowledgment 500 decreases. As a result, radio communication apparatus 100 can increase the speed of arrival-guaranteed data communication with radio communication apparatus 200.

Note that for the following reasons, virtually increasing receiving buffer size 320 poses no problem. In radio communication apparatus 100, receiving buffer memory 131 is shared by MAC layer section 130 and protocol adaptation layer section 120. Specifically, reception of received data 400 is limited by MAC layer section 130 through flow control with a MAC acknowledgment of MAC layer section 130. As a result, radio communication apparatus 100 can avoid continuous reception (overflow) of received data 400 equal to or greater than receiving buffer memory 131 in size. Thus, it poses no problem when radio communication apparatus 100 indicates, to radio communication apparatus 200, the virtual receiving buffer size that is a value obtained by virtually increasing receiving buffer size 320.

The description of an example of operation of radio communication apparatus 100 has been given thus far.

<Operation of Communication System>

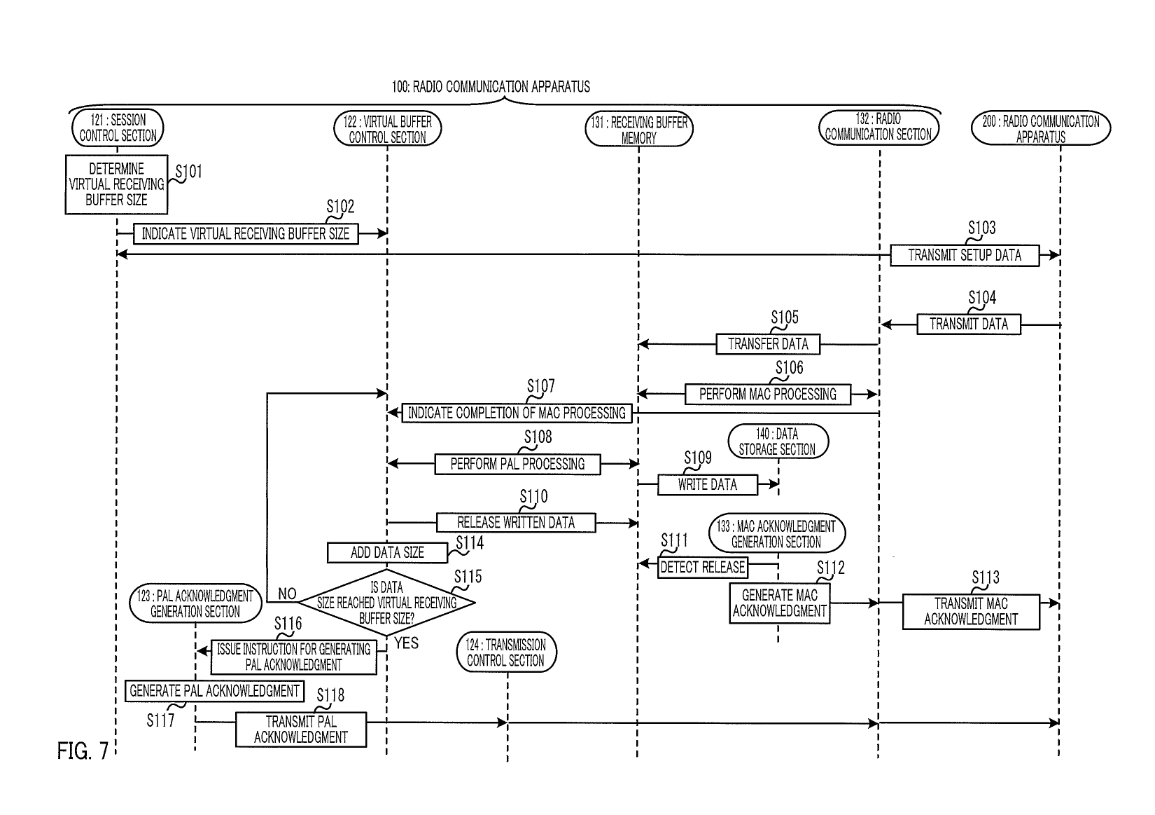

Hereinafter, radio communication apparatus 100 and radio communication apparatus 200 as a whole, that is, an example of operation of the communication system according to the present embodiment will be described with reference to FIG. 7.

FIG. 7 is a sequence diagram illustrating an example of operation when radio communication apparatus 100 receives arrival-guaranteed data from radio communication apparatus 200 via radio communication.

In step S101, upon receipt of an instruction for starting reception from higher layer section 110, session control section 121 transmits a session start request and receives a session start response (not shown), and then determines the virtual receiving buffer size. As described above, session control section 121 determines a value greater than at least the actual size of receiving buffer memory 131 to be the virtual receiving buffer size.

In step S102, session control section 121 indicates the determined virtual receiving buffer size to virtual buffer control section 122. Virtual buffer control section 122 that has received this indication stores the virtual receiving buffer size. In this step S102, session control section 121 may indicate, to virtual buffer control section 122, an instruction for writing received data 400 accumulated in receiving buffer memory 131 to data storage section 140. Virtual buffer control section 122 that has received this indication applies reception preparation processing (power supply start, initialization of writing region or the like) to data storage section 140.

In step S103, session control section 121 adds PAL header 310 to determined virtual receiving buffer size 320 and generates setup data 300. Session control section 121 then transmits setup data 300 to radio communication apparatus 200 via transmission control section 124 and radio communication section 132. In this case, radio communication apparatus 100 receives setup data 300 including the receiving buffer size of radio communication apparatus 200 from radio communication apparatus 200.

In step S104, higher layer section 210 of radio communication apparatus 200 generates received data 400 and transmits received data 400 to radio communication apparatus 100 via protocol adaptation layer section 220 and MAC layer section 230.

In step S105, upon receiving received data 400, radio communication section 132 transfers received data 400 to receiving buffer memory 131.

In step S106, radio communication section 132 performs MAC processing based on the MAC header of received data 400.

In step S107, upon completion of the MAC processing, radio communication section 132 indicates the completion of the MAC processing to virtual buffer control section 122. MAC acknowledgment generation section 133 then waits until PAL processing which will be described later is completed and received data 400 is released from receiving buffer memory 131.

In step S108, virtual buffer control section 122 performs PAL processing on received data 400 accumulated in receiving buffer memory 131 based on PAL header 410.

In step S109, when the PAL processing is completed, virtual buffer control section 122 performs control so as to remove PAL header 410 from received data 400 and write only data 430 to data storage section 140.

In step S110, upon completion of writing of data 430 to data storage section 140, virtual buffer control section 122 releases received data 400 including written data 430 from receiving buffer memory 131.

In step S111, MAC acknowledgment generation section 133 detects that received data 400 has been released from receiving buffer memory 131.

In step S112, MAC acknowledgment generation section 133 generates MAC acknowledgment 600 based on identification number 420 of released received data 400.

In step S113, MAC acknowledgment generation section 133 transmits generated MAC acknowledgment 600 to radio communication apparatus 200 via radio communication section 132. MAC layer section 230 of radio communication apparatus 200 resumes transmission of next received data 400 based on received MAC acknowledgment 600 (S104).

Note that steps S104 to S113 are repeated until radio communication apparatus 200 transmits all data 430 that can be transmitted without waiting for a PAL acknowledgment to radio communication apparatus 100. Specifically, transmission of data 430 is repeated between MAC layer section 130 of radio communication apparatus 100 and MAC layer section 230 of radio communication apparatus 200.

In step S114, virtual buffer control section 122 adds the size of data 430 written to data storage section 140 to the size of data 430 written so far and stores the result as an additional value. Virtual buffer control section 122 also stores identification number 420 of last written data 430.

In step S115, virtual buffer control section 122 determines whether or not the stored additional value has reached the virtual receiving buffer size indicated from session control section 121.

When the determination result in step S115 shows that the additional value has not reached the virtual receiving buffer size (S115: NO), virtual buffer control section 122 waits to receive processing on next received data 400 (indication of completion of MAC processing in S107).

When the determination result in step S115 shows that the additional value has reached the virtual receiving buffer size (S115: YES), the flow moves to step S116.

In step S116, virtual buffer control section 122 transmits an instruction for generating PAL acknowledgment 500 to PAL acknowledgment generation section 123. In this case, virtual buffer control section 122 also indicates identification number 420 of last written data 430 to PAL acknowledgment generation section 123.

In step S117, PAL acknowledgment generation section 123 receives an instruction for generating PAL acknowledgment 500 from virtual buffer control section 122. PAL acknowledgment generation section 123 then generates PAL acknowledgment 500 based on identification number 420 indicated from virtual buffer control section 122.

In step S118, PAL acknowledgment generation section 123 transmits generated PAL acknowledgment 500 to radio communication apparatus 200 via transmission control section 124 and radio communication section 132.

Thus, radio communication apparatus 100 virtually increases receiving buffer size 320 and indicates the increased receiving buffer size 320 to radio communication apparatus 200, and can thereby increase the amount of data that can be transmitted by radio communication apparatus 200 to radio communication apparatus 100 without waiting for a PAL acknowledgment. Thus, radio communication apparatus 100 can reduce the number of times PAL acknowledgment 500 is indicated to radio communication apparatus 100. As a result, the time for which radio communication apparatus 200 waits to receive PAL acknowledgment 500 is reduced. As a result, radio communication apparatus 100 can increase the speed of arrival-guaranteed data communication with radio communication apparatus 200.

Virtually increasing receiving buffer size 320 will pose no problem for the following reason. In radio communication apparatus 100, receiving buffer memory 131 is shared by MAC layer section 130 and protocol adaptation layer section 120. Specifically, reception of received data 400 is limited by MAC layer section 130 through flow control with a MAC acknowledgment by MAC layer section 130. As a result, radio communication apparatus 100 can avoid continuous reception (overflow) of data 400 equal to or greater than receiving buffer memory 131 in size. Thus, it poses no problem when radio communication apparatus 100 indicates, to radio communication apparatus 200, the virtual receiving buffer size that is a value obtained by virtually increasing receiving buffer size 320.

<Variations of Embodiment>

The present embodiment has been described so far, but the description is an example and various modifications are possible. Hereinafter, variations will be described.

The above-described embodiment assumes that virtual receiving buffer size 320 determined by session control section 121 is a value greater than the actual size of receiving buffer memory 131, but the present invention is not limited to this. For example, when the speed of writing (hereinafter, referred to as “writing speed”) from receiving buffer memory 131 to data storage section 140 is extremely low, session control section 121 operates as follows. Specifically, session control section 121 may determine virtual receiving buffer size 320 indicated with setup data 300 not to be a virtual value but to be a value whose upper limit is the actual size of receiving buffer memory 131. If the virtual receiving buffer size is set in a case where it takes time to write data to data storage section 140, PAL acknowledgment generation section 123 cannot generate PAL acknowledgment 500 for a long period of time. This may cause retransmission of received data 400 by radio communication apparatus 200. Session control section 121 may change virtual receiving buffer size 320 indicated by setup data 300 according to the type of data storage section 140 as appropriate. Types of data storage section 140 are, for example, an SD, SDHC or SDXC card. In this case, an SDXC card has the highest writing speed and an SD card has the slowest writing speed. Note that the receiving buffer size defined in the communication protocol of protocol adaptation layer section 120 may be smaller than the actual size of receiving buffer memory 131. In such a case, session control section 121 may determines a PAL-defined receiving buffer size to be virtual receiving buffer size 320. The “PAL-defined receiving buffer size” refers to the receiving buffer size defined in the communication protocol of protocol adaptation layer section 120.

An example has been described in the above-described embodiment where virtual buffer control section 122 indicates identification number 420 to PAL acknowledgment generation section 123 when instructing generation of PAL acknowledgment 500, but the present invention is not limited to this. For example, virtual buffer control section 122 may indicate, to PAL acknowledgment generation section 123, information indicating the total size of received data 400 successfully received from radio communication apparatus 200 instead of identification number 420. Alternatively, for example, virtual buffer control section 122 may indicate information indicating the size of received data 400 that has not been transmitted by radio communication apparatus 200 yet. This information is calculated by virtual buffer control section 122 based on the total size of received data 400 finally received by radio communication apparatus 100.

An example has been described in the above-described embodiment where virtual buffer control section 122 determines whether or not an additional value of the size of data 430 which had already been written has reached the virtual receiving buffer size, but the present invention is not limited to this. For example, virtual buffer control section 122 may also determine whether or not the additional value has reached a threshold that is close to the virtual receiving buffer size. In this case, even when radio communication apparatus 200 does not transmit data corresponding to the virtual receiving buffer size, radio communication apparatus 200 can generate a PAL acknowledgment and transmit it to radio communication apparatus 100. When the above-described threshold is not set and radio communication apparatus 200 does not transmit data corresponding to the virtual receiving buffer size, protocol adaptation layer section 120 enters standby. At this time, virtual buffer control section 122 detects that the continuity of reception of received data 400 is interrupted (data is not received for a certain period of time). At the detection timing, virtual buffer control section 122 may instruct PAL acknowledgment generation section 123 to generate a PAL acknowledgment. Specifically, when protocol adaptation layer section 120 enters standby because the continuity of reception of received data 400 is interrupted, radio communication apparatus 100 may transmit PAL acknowledgment 500 to radio communication apparatus 200. Thus, efficient processing can be performed also from the standpoint of making full use of resources such as the CPU.

The embodiments have been described above using an example in which the present invention is implemented by hardware, but the present invention can be implemented by software in concert with hardware.

As has been described thus far, the radio communication apparatus according to this disclosure is a radio communication apparatus that performs radio communication with another radio communication apparatus using arrival-guaranteed data communication, the radio communication apparatus including: a MAC (Media Access Control) layer section that temporarily stores data received from the other radio communication apparatus in a receiving buffer memory; and a protocol adaptation layer (PAL) section that indicates, to the other radio communication apparatus, as a virtual receiving buffer size, a value greater than an actual size of the receiving buffer memory shared with the MAC layer, before starting reception of data from the other radio communication apparatus, that writes the data stored in the receiving buffer memory to a recording medium, that generates an acknowledgment when a total size of the data written to the recording medium reaches the virtual receiving buffer size, and that transmits the acknowledgment to the other radio communication apparatus.

In the radio communication apparatus according to this disclosure, the protocol adaptation layer section generates a PAL acknowledgment and transmits the PAL acknowledgment to the other radio communication apparatus in a case where the total size of the data written to the recording medium reaches a threshold close to the virtual receiving buffer size instead of a case where the total size reaches the virtual receiving buffer size.

In the radio communication apparatus according to this disclosure, the protocol adaptation layer section indicates, to the other radio communication apparatus, a value greater than the actual size of the receiving buffer memory and smaller than an upper limit value defined in a communication protocol of the protocol adaptation layer section, as the virtual receiving buffer size.

In the radio communication apparatus according to this disclosure: the protocol adaptation layer section releases the data written from the receiving buffer memory to the recording medium from the receiving buffer memory; and upon detecting the release, the

MAC layer section generates a MAC acknowledgment and transmits the MAC acknowledgment to the other radio communication apparatus.

In the radio communication apparatus according to this disclosure, when it is detected that no data has been received from the other radio communication apparatus for a certain period, the protocol adaptation layer section generates the PAL acknowledgment based on identification information of the data last written from the receiving buffer memory to the recording medium, and indicates the PAL acknowledgment to the other radio communication apparatus.

In the radio communication apparatus according to this disclosure, when the speed at which data is written from the receiving buffer memory to the recording medium is low, the protocol adaptation layer section indicates, to the other radio communication apparatus, a value whose upper limit is the actual size of the receiving buffer memory, instead of the virtual receiving buffer size.

The radio communication method according to this disclosure is a radio communication method for performing radio communication with a radio communication apparatus using arrival-guaranteed data communication, the radio communication method including: indicating, by a protocol adaptation layer section to the radio communication apparatus, as a virtual receiving buffer size, a value greater than the actual size of a receiving buffer memory shared with a MAC (Media Access Control) layer section, before reception of data from the radio communication apparatus starts; temporarily storing, by the MAC layer section, the data received from the radio communication apparatus in the receiving buffer memory; writing the data from the receiving buffer memory to a recording medium by the protocol adaptation layer section; and generating an acknowledgment and transmitting the acknowledgment to the radio communication apparatus by the protocol adaptation layer section when a total size of the data written to the recording medium reaches the virtual receiving buffer size.

The radio communication control program according to this disclosure is a radio communication control program to be executed by a computer of an apparatus that performs radio communication with another radio communication apparatus using arrival-guaranteed data communication, the radio communication control program causing the computer to execute processes including: indicating, by a protocol adaptation layer section to the other radio communication apparatus, as a virtual receiving buffer size, a value greater than the actual size of a receiving buffer memory shared with a MAC (Media Access Control) layer section, before reception of data from the other radio communication apparatus starts; temporarily storing, by the MAC layer section, the data received from the other radio communication apparatus in the receiving buffer memory; writing the data from the receiving buffer memory to a recording medium by the protocol adaptation layer section; and generating an acknowledgment and transmitting the acknowledgment to the other radio communication apparatus by the protocol adaptation layer section when a total size of the data written to the recording medium reaches the virtual receiving buffer size.

The disclosure of Japanese Patent Application No. 2012-224081, filed on Oct. 9, 2012, including the specification, drawings and abstract, is incorporated herein by reference in its entirety.

### INDUSTRIAL APPLICABILITY

The present invention is useful as a radio communication apparatus, a radio communication method, and a radio communication control program that can increase the speed of arrival-guaranteed data reception from another radio communication apparatus connected via radio communication. The present invention is applicable, for example, to a portable device such as mobile phone and tablet, and a personal computer.

### REFERENCE SIGNS LIST

100 Radio communication apparatus
110 Higher layer section
120 Protocol adaptation layer section (PAL)
121 Session control section
122 Virtual buffer control section
123 PAL acknowledgment generation section
124 Transmission control section
130 MAC layer section
131 Receiving buffer memory
132 Radio communication section
133 MAC acknowledgment generation section
140 Data storage section
200 Radio communication apparatus
210 Higher layer section
220 Protocol adaptation layer section (PAL)
230 MAC layer section

1. A radio communication apparatus that performs radio communication with another radio communication apparatus using arrival-guaranteed data communication, the radio communication apparatus comprising:
a MAC (Media Access Control) layer section that temporarily stores data received from the other radio communication apparatus in a receiving buffer memory; and
a protocol adaptation layer (PAL) section that indicates, to the other radio communication apparatus, as a virtual receiving buffer size, a value greater than an actual size of the receiving buffer memory shared with the MAC layer, before starting reception of data from the other radio communication apparatus, that writes the data stored in the receiving buffer memory to a recording medium, that generates an acknowledgment when a total size of the data written to the recording medium reaches the virtual receiving buffer size, and that transmits the acknowledgment to the other radio communication apparatus.

2. The radio communication apparatus according to claim 1, wherein the protocol adaptation layer section generates a PAL acknowledgment and transmits the PAL acknowledgment to the other radio communication apparatus in a case where the total size of the data written to the recording medium reaches a threshold close to the virtual receiving buffer size instead of a case where the total size reaches the virtual receiving buffer size.

3. The radio communication apparatus according to claim 1, wherein the protocol adaptation layer section indicates, to the other radio communication apparatus, a value greater than the actual size of the receiving buffer memory and smaller than an upper limit value defined in a communication protocol of the protocol adaptation layer section, as the virtual receiving buffer size.

4. The radio communication apparatus according to claim 1, wherein:
the protocol adaptation layer section releases the data written from the receiving buffer memory to the recording medium from the receiving buffer memory; and
upon detecting the release, the MAC layer section generates a MAC acknowledgment and transmits the MAC acknowledgment to the other radio communication apparatus.

5. The radio communication apparatus according to claim 1, wherein, when it is detected that no data has been received from the other radio communication apparatus for a certain period, the protocol adaptation layer section generates the PAL acknowledgment based on identification information of the data last written from the receiving buffer memory to the recording medium, and indicates the PAL acknowledgment to the other radio communication apparatus.

6. The radio communication apparatus according to claim 1, wherein, when the speed at which data is written from the receiving buffer memory to the recording medium is low, the protocol adaptation layer section indicates, to the other radio communication apparatus, a value whose upper limit is the actual size of the receiving buffer memory, instead of the virtual receiving buffer size.

7. A radio communication method for performing radio communication with a radio communication apparatus using arrival-guaranteed data communication, the radio communication method comprising:
indicating, by a protocol adaptation layer section to the radio communication apparatus, as a virtual receiving buffer size, a value greater than the actual size of a receiving buffer memory shared with a MAC (Media Access Control) layer section, before reception of data from the radio communication apparatus starts;
temporarily storing, by the MAC layer section, the data received from the radio communication apparatus in the receiving buffer memory;
writing the data from the receiving buffer memory to a recording medium by the protocol adaptation layer section; and
generating an acknowledgment and transmitting the acknowledgment to the radio communication apparatus by the protocol adaptation layer section when a total size of the data written to the recording medium reaches the virtual receiving buffer size.

8. A radio communication control program to be executed by a computer of an apparatus that performs radio communication with another radio communication apparatus using arrival-guaranteed data communication, the radio communication control program causing the computer to execute processes comprising:
indicating, by a protocol adaptation layer section to the other radio communication apparatus, as a virtual receiving buffer size, a value greater than the actual size of a receiving buffer memory shared with a MAC (Media Access Control) layer section, before reception of data from the other radio communication apparatus starts;
temporarily storing, by the MAC layer section, the data received from the other radio communication apparatus in the receiving buffer memory;
writing the data from the receiving buffer memory to a recording medium by the protocol adaptation layer section; and
generating an acknowledgment and transmitting the acknowledgment to the other radio communication apparatus by the protocol adaptation layer section when a total size of the data written to the recording medium reaches the virtual receiving buffer size.
